(19) United States
(12) Patent Application Publication
(10) Pub. No.: US 2025/0250185 A1
(43) Pub. Date: Aug. 7, 2025

(54) INSTALLATION AND METHOD FOR CLEANING A STREAM OF OIL

(71) Applicants: SAXONTECHNOLOGIES SARL, NYON (CH); ALFALUZ S.A., MONTEVIDEO (UY)

(72) Inventors: OSCAR ANTONIO COUSTASSE MAASS, ARCAJU (BR); RANDOLF WAYNE BRAWN, MONTEVIDEO (UY)

(21) Appl. No.: 18/856,220

(22) PCT Filed: Apr. 11, 2023
(86) PCT No.: PCT/IB2023/053700

§ 371 Date: Oct. 11, 2024

(30) Foreign Application Priority Data
Apr. 11, 2022 (CH) CH000407/2022

(51) Int. Cl. C02F 1/463; C02F 1/38; C02F 1/461; C02F 1/48

(52) U.S. Cl. CPC C02F 1/463; C02F 1/385; C02F 1/46109; C02F 1/482; C02F 1/488; C02F 2001/46152

(57) ABSTRACT

This invention concerns an installation and method for treating a first stream (S1) of a colloidal suspension of water and ultra-fine particles and a second stream (S2) of heavy oil, both of which streams are derived from treating a flow of heavy crude oil or bitumen, to convert them into separate streams of clean water, clean oil, decanted solids and usable gases. The first stream (S1) is treated in a series of electro-kinetic reactors (20) operating by electrolysis/electro flocculation and water tank clarifiers (30) connected in parallel. The second stream (S2) is treated in ultrasound cyclone chambers (40). Released gas is collected from the tops of the electro-kinetic reactors (20) and the ultrasound cyclone chambers (40). Decanted solids are collected from the bottoms of the electro-kinetic reactors (20) and the ultrasound cyclone chambers (40). Clean water is collected from the water tank clarifiers (30). Clean oil is collected from the ultrasound cyclone chambers (40).

### FIELD OF THE INVENTION

This invention relates to the treatment of heavy crude oil and bitumen and is particularly concerned with an installation and method for treating a first stream of a colloidal suspension of water and ultra-fine particles and a second stream of heavy oil, both of which streams are derived from treating a flow of heavy crude oil or bitumen.

### BACKGROUND OF THE INVENTION

Heavy crude oil as well as bitumen are highly contaminant and expensive to produce and refine. Now, with the world climate crisis, the oil Industry is trying to find solutions to de-carbonize its production matrix. This invention is a contribution to the above-mentioned need.

This invention is related to natural bitumen and heavy crude oil partial upgrading by separating ultra-fines from a colloidal dispersion with the aim of maximizing water and energy efficiency and to replace contaminating fuels and processes.

The technique of electrolyzing water in the presence of an electrolyte such as sodium hydroxide (NaOH) or potassium hydroxide (KOH) to liberate hydrogen and oxygen gas (H₂, O₂) is well known. The process involves applying a DC potential difference between two or more anode/cathode electrode pairs and delivering the minimum energy required to break the H—O bonds (i.e. 68.3 kcal per mole at STP). The gases are produced in the stoichiometric proportion O₂:H₂ 1:2 liberated respectively from the anode (+) and cathode (−).

Reference can be made to the following texts: “Modern Electrochemistry, Volume 2, by John O'M. Bockris and Amulya K. N. Reddy, (Plenum Publishing Corporation)”, “Electro-Chemical Science,” by J. O'M. Bockris and D. M. Drazic, (Taylor and Francis Limited) and “Fuel Cells, Their Electrochemistry,” by J. O'M. Bockris and S. Srinivasan, (McGraw-Hill Book Company).

Electroflocculation is a technique for the removal of pollutants from waste-water. In electroflocculation, metal ions (which act as a coagulating or flocculating agent) are released into solution from an anode by the action of a current. Electroflocculation also leads to the generation of hydrogen gas at the cathode as a result of the chemical reduction of water molecules. The coagulating agent (metal ions) combines with the pollutants and the coagulated pollutants may then be captured by the rising gas bubbles, resulting in most of the pollutant floating to the surface. Additionally, pollutant which does not rise to the surface with the gas bubbles often sediments out, thus facilitating its removal.

Electroflocculation has also been shown to remove many common waste-water impurities including for example large dissolved molecules, bacteria, algae and other materials. As specific examples, electroflocculation has been shown to be effective for the removal of the following from waste-water: textile and printing dyes, humus; dissolved heavy metal cations; emulsified fats, oils and greases; and phosphates. In electroflocculation systems, it is eventually necessary to separate the treated water from the froth generated during the process. In existing electroflocculation processes, separation of the froth from the treated water is typically achieved by sedimentation or filtration. However, sedimentation systems are generally amenable only to situations where the treated liquid can be left to settle with little or no disturbance. Furthermore, filtration-based systems generally require a further system to prevent blockage of the filter by the troth, which (in addition to the extra filters themselves) add to the complexity, cost and size of the apparatus.

Ultrasonic enhanced oil recovery technology has been applied in many aspects of the petroleum industry, including demulsification by ultrasonic wave, oil pollution treatment by ultrasonic wave, wax prevention by ultrasonic wave, plugging removal by ultrasonic wave, and viscosity reduction of heavy oil by ultrasonic wave.

The main principle of ultrasonic demulsification technology is that oil and water particles continuously move to the wave belly and node due to the cavitation effect, thermal effect, and displacement effect produced by vibration, and then coalesce to generate water and oil droplets with larger diameters, and finally separate the oil and water by gravity. The application of ultrasonic technology greatly promotes the demulsification and dehydration effect of emulsion.

By ultrasonic cavitation, the macromolecular hydrocarbons in heavy oil can be reduced into small molecular hydrocarbons, which can realize the separation of crude oil and sludge.

Ultrasonic plug removal technology is widely used in China's oilfields. The main principle of this technology is that the water plugging, organic fouling, inorganic scale blockage, and polymer gel plugging can be removed through the cavitation and vibration of ultrasonic wave; thus, the permeability near the well area can be restored, and the effect of water injection and oil recovery can be enhanced.

The main principle of this technology is to produce local high temperature, high pressure, and strong physical disturbance in the fluid instantaneously through cavitation, heat, and physical shaking and thixotropy of ultrasonic wave, thus reducing the viscosity and improving the fluidity of heavy oil. This technology has the advantages of high efficiency, low cost, and low pollution.

Ultrasound effects the oxidative desulfurization of hydrocarbons in heavy oil and asphaltene separation through physical shaking and thixotropy, the extent to which chemical cavitation reduces the viscosity of crude oil, and the microscopic mechanism of chemical action.

Water is clarified when crude oil viscosity is reduced by ultrasonic waves. The mechanism of chemical viscosity reduction by ultrasonic cavitation is the combination of the heavy oil heteroatom broken bond and ionized hydrogen radical in water.

### PRIOR ART

US Patent Application 2015/0076073 discloses a process for single system electrocoagulation, magnetic cavitation and flocculation treatment of wastewater including wastewater from the oil and gas industry, by sequential passage through different units.

A process for treating crude oil and bitumen known as the M-CRACK process with its MCT sub-system are described in the websites www.alfaluz.net and www.alfaluz.ca.

The described M-CRACK process treats a stream of crude oil and produces two streams to be treated in the MCT separator. The two streams are (i) water with suspended ultra-fine negatively charged particles as a colloidal dispersion, heavy metals and dissolved salts and (ii) oil with water and little content of ultra-fine particles. In the known M-CRACK process, the two above mentioned streams are obtained to be further treated at the MCT sub-system The outputs of the M-CRACK process are clean water, cleaned decanted solids and clean oil.

### SUMMARY OF THE INVENTION

The present invention relates to the process of improving oil quality in terms of density, viscosity, water content, solids content, sulfur content and acidity using centrifugal forces, ultrasound, electrokinetic forces, magnetic forces and gravity forces, while at the same time cleaning the water from ultra-fine materials in colloidal dispersion and dissolved salts in water. As a by-product of the process hydrogen gases, oxygen gases and chloride gases from water are generated by the process of electrolysis, and other gases produced ultrasound are collected, for further applications that use the liberated gas. Embodiments of the invention particularly relate to a series of apparatus for the efficient partial up-grading of the crude oil, separation of ultra-fine solids and generation of gases to be used to replace natural gases usage in boilers and or to generate electricity.

The present invention thus provides an installation and method to clean water from contaminants and upgrade heavy oil and provide valuable outputs.

The invention in particular concerns an installation for treating a first stream of a colloidal suspension of water and ultra-fine particles and a second stream of heavy oil, both of which streams are derived from treating a flow of heavy crude oil or bitumen, to convert the first and second streams into separate streams of clean water and clean oil, decanted solids and released gases.

The inventive installation comprises a plurality of electro-kinetic reactors and water tank clarifiers connected in parallel to receive and treat said first stream; and at least one ultrasound cyclone chamber connected to receive and treat said second stream.

Each electro-kinetic reactor of the inventive installation comprises:
an involute inlet connected to receive the first stream,
an innovative set of spaced apart anodes and cathodes arranged in the reactor to electrolyze the first stream,
a top outlet arranged to release generated gases,
a lower outlet arranged to extract partly clarified water containing ultra-fine particles and ferric material, and
a bottom funnel with a bottom outlet arranged to extract decanted solids;

Each water tank clarifier of the inventive installation comprises:
an inlet connected to the lower outlet of the electro-kinetic reactor to receive the partly clarified water,
an innovative electro-magnetic belt surrounding the water tank clarifier and arranged to magnetically urge the ultra-fine ferric material in the partly clarified water towards the bottom of the water tank clarifier,
an outlet in the bottom of the water tank clarifier arranged to remove solids, and
a clean water outlet.

The or each ultrasound cyclone chamber of the inventive installation comprises:
an innovative tangential inlet connected to receive the second stream,
a cyclone chamber configured to cyclonically deliver the inlet second stream,
an ultrasound generator comprising an innovative array of transducers arranged to sonicate oil, salts and heavy metals contained in the second stream as it is delivered through the cyclone chamber and to accelerate dropping of solids to a bottom outlet in the cyclone chamber,
a top outlet arranged to release generated gases, and
a further outlet in the cyclone chamber arranged to deliver clean oil.

The plurality of electro-kinetic reactors and water tank clarifiers and the or each ultrasound cyclone chamber of the inventive installation are interconnected as follows.

The inlets of all electro-kinetic reactors are all connected to a common feed conduit of the first stream to receive the first stream.

The top outlets of all electro-kinetic reactors and the top outlet of the or each cyclone chamber are all connected to a common gas extraction conduit.

The clean water outlets of all water tank clarifiers are all connected to a common clean water delivery conduit.

The outlets of the bottom funnels of all electro-kinetic reactors, the outlets in the bottom of all water tank clarifiers, and the bottom outlet in the or each ultrasound cyclone chamber are all connected to a common solids separation conduit.

The inventive installation thus converts the input first stream and the input second stream into outputs of gas, decanted solids, clean water and clean oil.

In a preferred embodiment of the inventive installation, the top outlet of each electro-kinetic reactor and the top outlet of the or each ultrasound cyclone chamber are each connected to the common gas extraction conduit by a pressure relief valve and a flame arrester.

In another preferred embodiment of the inventive installation, each inlet and each outlet of the electro-kinetic reactors, of the water tank clarifiers and of the or each ultrasound cyclone chamber comprises a solenoid valve.

Preferably, each water tank clarifier is a cyclone with an upper tangential inlet that is connected to the lower outlet of the electro-kinetic reactor to receive the partly clarified water, and a lower clean water outlet.

Advantageously, the spaced apart anodes and cathodes of each electro-kinetic reactor comprise an array of interleaved part-cylindrical anodes and cathodes disposed concentrically and spaced-apart with equal spacings. For instance, each electro-kinetic reactor comprises two sets of equal facing half cylindrical anodes and cathodes each disposed concentrically and spaced-apart with equal spacings, the two sets of equal facing half cylindrical anodes and cathodes making up a generally cylindrical array with facing halves separated by a radially-extending gap across which extremities of the anodes and cathodes of the two sets face one another, and wherein the facing anodes and cathodes of the generally cylindrical array define circular circulation paths for the first stream.

Another aspect of the invention is a method of operating the above-defined installation to treat a first stream of a colloidal suspension of water and ultra-fine particles and a second stream of heavy oil, both of which streams are derived from treating a flow of heavy crude oil or bitumen, to convert the first and second streams into separate streams of clean water and clean oil, decanted solids and released gases.

The inventive method comprises:
delivering the first stream to the inlets of the electro-kinetic reactors via the common supply conduit,
delivering the second steam to the tangential inlet of the or each ultrasound cyclone chamber,
removing gases via the common gas extraction conduit that is connected to the top outlets of all electro-kinetic reactors and the top outlet of the or each ultrasound cyclone chamber,
removing clean water via the common clean water delivery conduit connected to the clean water outlets of the water tank clarifiers,
removing separated solids via the common solids separation conduit that is connected to the outlets of the bottom funnels of the electro-kinetic reactors, the outlets in the bottom of the water tank clarifiers, and the bottom outlet in the or each ultrasound cyclone chamber, and
removing clean oil from the further outlet in the or each ultrasound cyclone chamber.

In the electro-kinetic reactors, the inventive method preferably involves;
electrolyzing the first stream between facing anodes and cathodes in each electro-kinetic reactor,
releasing generated gases via the top outlet of each electro-kinetic reactor,
extracting partly clarified water containing ultra-fine and ferric material via the lower outlet of each electro-kinetic reactor, and
extracting decanted solids via the outlet of each electro-kinetic reactor's bottom funnel.
The first stream can be electrolyzed in each electro-kinetic reactor with an effect of electroflocculation by appropriate choice of the anode and cathode materials, with produced flocculated material being removed from the electro-kinetic reactor via a side outlet.

Advantageously, the first stream is circulated in each electro-kinetic reactor around the circular circulation paths between the facing anodes and cathodes.

The inventive method preferably also involves
delivering partly clarified water from the lower outlet of each electro-kinetic reactor to the upper inlet of its water tank clarifier,
magnetically urging ultra-fine and ferric material in the partly clarified water contained in each water tank clarifier towards the outlet in its bottom, and out letting clean water from each water tank clarifier.

The inventive method preferably also involves:
cyclonically delivering the second stream through the or each ultrasound cyclone chamber,
generating ultrasound in the array of transducers in the or each ultrasound cyclone chamber to sonicate oil, salts and heavy metals contained in said second stream as it is delivered through the cyclone chamber to accelerate dropping of solids to the bottom outlet in the or each cyclone chamber,
out letting generated gases via the top outlet of the or each cyclone chamber, and
delivering clean oil from said further outlet in the or each ultrasound cyclone chamber.

### BRIEF DESCRIPTION OF THE DRAWINGS

The invention will be further described by way of example with reference to the accompanying schematic drawings wherein:

FIG. 1 is a diagram illustrating an overall installation for crude oil/bitumen treatment into which an installation according to the invention can be integrated.

FIG. 2 is a diagram of an installation according to the invention.

FIG. 3 is a front view of an electro-kinetic reactor of the inventive installation.

FIG. 4 is a top view showing the configuration of electrodes located on top of electro-kinetic reactor inlet.

FIG. 5 shows a decanter clarifier of the inventive installation.

FIG. 6 is a general view of a cyclone chamber with a detail of its tangential inlet.

### DETAILED DESCRIPTION

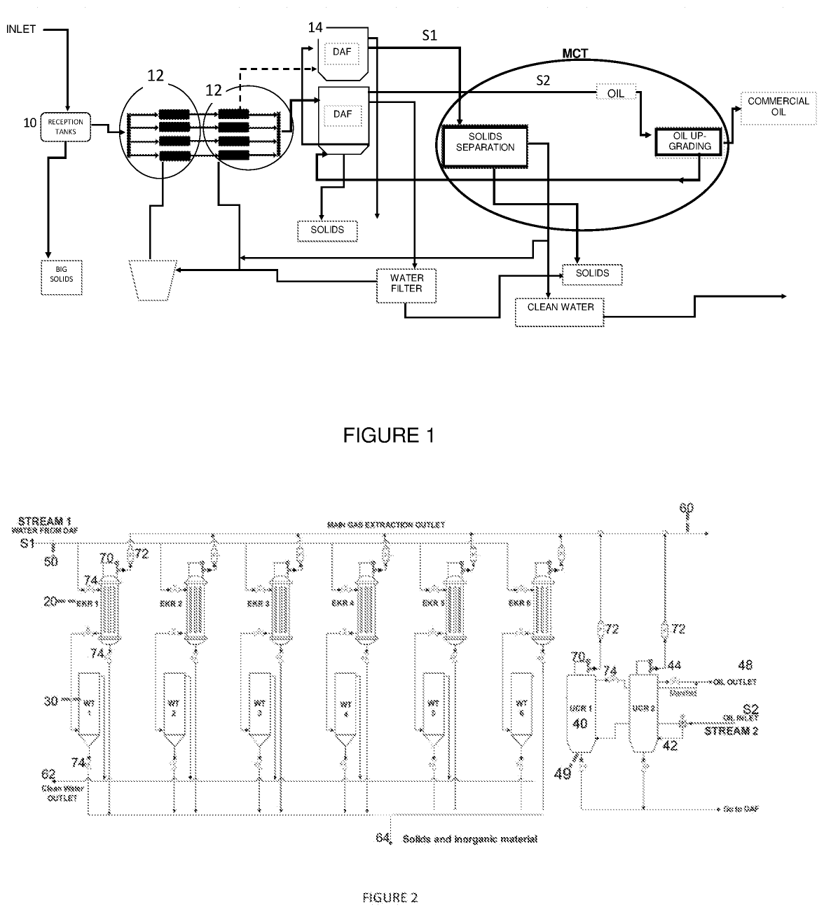

FIG. 1 is a schematic flow diagram of an overall installation for treating crude oil and bitumen that corresponds to a version of the prior art M-CRACK system with its MCT unit.

As shown in FIG. 1, crude oil and bitumen to be treated are received in reception tanks 10 where big solids are removed. The stream of crude oil and bitumen containing positively charged particles is then passed through two injection chambers 12 where a liquid agent is injected to reverse the charges of the particles in the crude oil and eliminate H2S.

For this purpose, the liquid agent to be hydro blasted into the injection chambers IC is available from ALFALUZ S.A. of Montevideo, Uruguay under the trade name PETROMAX™.

This results in an emulsion of negatively charged solid particles in a water/crude oil mixture that is susceptible to be separated and is delivered to dual Dissolved Air Flotation chambers (DAF) 14 for separation.

In the injection chambers 12 the liquid agent hydro blasted into the bitumen, heavy oil, oil sands ore, oil processing tailings and contaminated soil has the following effects:

### High Pressure Penetration

The resins that are covering the solids are penetrated by force and the strong bond with solids is broken (clay, sand, quartz, asphaltenes, others).

### Mixing at High Pressure

The solids are energized to create a flow in which the most complicated compounds are suspended and uniformly dispersed (colloidal dispersion).

The weaker bonds are broken so the solids such as the heavy molecular weight asphaltenes, some paraffin and heavy metals will not be re-attached to the heavy oil.

After passing through the Injection Chamber 12, the main results on the bitumen are:

The emulsion has been broken. The solids are free of hydrocarbons. Fine particles, some resins, some paraffin and black powder are suspended in the fluid (colloidal suspension). Approximately 50% of the asphaltenes will be encapsulated so they will be separated along with the sand and other fine and ultra-fine particles at the MCT other than the reduction of H2S. In bitumen more than 80% of the sulfur will be bonded to the asphaltenes which will be separated from the oil. Therefore, the final content of sulfur will also be reduced.

The lower DAF 14 unit separates the emulsion into: cleaned fine particles and heaviest asphaltenes that are removed from its; water that is recycled to the injection chambers 12; and partly purified oil that is delivered to the MCT unit. The lower DAF unit 14 delivers, to the upper DAF unit 14, solids that are separated from the emulsion and water. The upper DAF unit 14 delivers to the MCT unit a stream of water containing fine charged particles in colloidal dispersion.

The MCT unit thus receives two streams: (S1) a stream of water containing fine negatively charged particles, and (S2) a stream of partly purified oil.

In the illustrated MCT unit:
the stream (S1) is divided into two, i.e. into a stream of water that is recycled to the injection chambers, and a residue of cleaned fine particles and heaviest ashphaltenes. This includes resins, asphaltenes, sulfur, crystalized paraffin, heavy metals and crystalized salt.
the stream (S2) is delivered to an oil upgrading unit that delivers on the one hand clean commercial oil, and on the other hand and a residue of cleaned fine particles and heaviest ashphaltenes that can be collected with those from the first stream.

The two main outputs of the known M-CRACK system are:
1. Clean water that is separated and recirculated within the M-CRACK system and can be delivered to the central processing facility of the oil company.
2. Commercial grade clean oil.

The installation according to the invention receives the same two streams (S1) and (S2) as described for FIG. 1, but the installation according to the invention advantageously replaces, and is an alternative to, the MCT unit illustrated in FIG. 1.

As mentioned, the MCT receives two streams from the previous process. These are the same two streams that are treated in the installation according to the invention.
Stream S1: Contaminated water. Ultra fine clay in suspension, dissolved salts, other ultra-fine material, etc.
Stream S2: Partly purified non-commercial oil that still contains some sulfur, asphaltene, water, fine particles and salts.

FIG. 2 is a diagram of a preferred embodiment of an installation according to the invention that comprises six electro-kinetic reactors 20 and six water tank clarifiers 30 connected in parallel cascade to receive a first stream S1 of contaminated water, and two ultrasound cyclone chambers 40 connected to receive and treat a second stream S2 of partly purified oil.

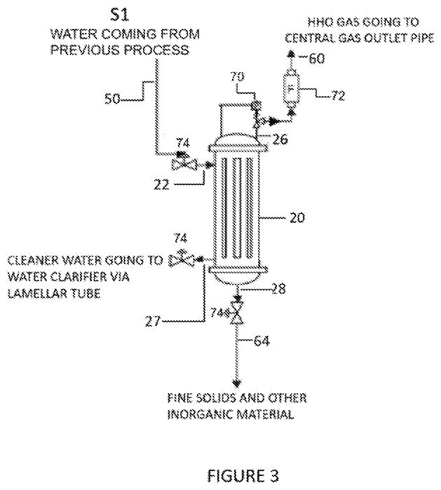

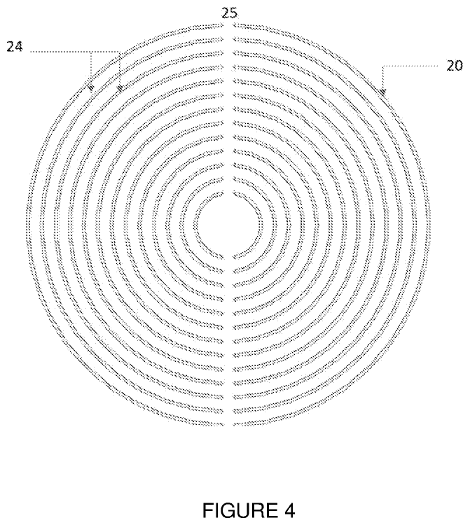

The electro-kinetic reactors EKR 20 are shown in FIG. 2 and FIG. 3. Each electro-kinetic reactor EKR 1 to EKR 6 comprises: an involute inlet 22 connected via a solenoid valve 74 to receive the first stream S1 from a main supply conduit 50; a set of spaced apart anodes and cathodes 24 (see FIG. 4) arranged in the reactor 20 to electrolyze the first stream S1; a top outlet 26 arranged to release generated gases to a common gas extraction conduit 60 via a pressure relief valve 70 and a flashback flame arrestor 72; a lower lamellar outlet 27 with a solenoid valve 74 arranged to extract partly clarified water containing ultra-fine ferric material; and a bottom funnel with a bottom outlet 28 arranged to extract decanted solids via a solenoid valve 74.

FIG. 4 is a schematic top view illustrating the configuration of how the electrodes 24 are located inside of the EKR reactor 20. The arrangement comprises a plurality of anode-forming electrodes in a convex relationship, each anode electrode comprising a convex plate through which one or more first common conductive interconnect elements pass. There is a plurality of cathode-forming electrodes in convex opposite relationship to the first, each cathode electrode comprising a convex plate through which pass one or more second common conductive interconnect elements. The anode electrodes and the cathode electrodes are interleaved to form between them a series of circular circulation paths for the first stream passing through the reactor. The facing half cylindrical units of the anodes and cathodes 24 are separated by a radially extending gap 25.

By making at least the anodes for example of iron that release Fe+ions, the arrangement produces electrocoagulation of water to release hydrogen, oxygen and chlorate gases.

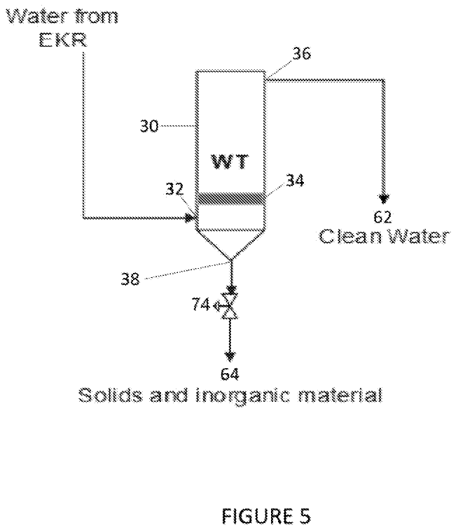

Immediately under each EKR 20, a water tank clarifier WT 30 is located. The water tank clarifier provides the residence time for the flocs and other solid material to settle at its bottom. The WT clarifier is shown in FIG. 5. It is a Decanter Tank designed specially design for these purposes and enhanced with magnetic forces that will force the ultra-fine ferric material to easily drop to the cone of the tank for further removal.

FIG. 2 and FIG. 3 show the water tank clarifiers WT 3030. Each water tank clarifier WT 30 comprises: an inlet 32 connected to the lower outlet 27 of the electro-kinetic reactor 20 to receive the partly clarified water; an electro-magnetic belt 34 surrounding the water tank clarifier 30 and arranged to magnetically urge the ultra-fine ferric material in the partly clarified water towards the bottom of the water tank clarifier with no blockage creation; an outlet 38 in the bottom of the water tank clarifier 30 arranged to remove solids vi a solenoid valve 74; and a clean water outlet 36 connected to a common clean water delivery conduit 62.

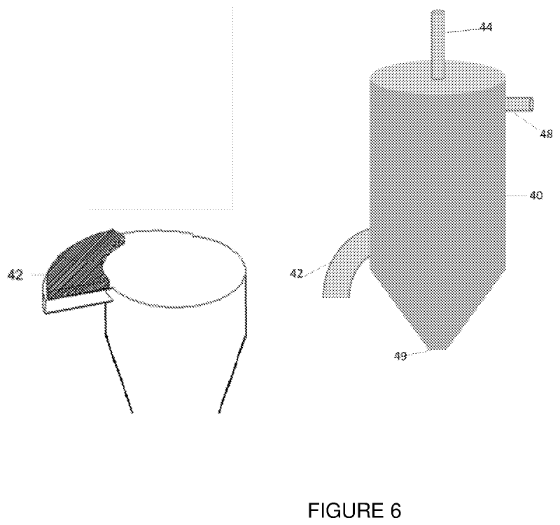

FIG. 2 and FIG. 6 show the ultrasound cyclone chambers UCR 40. Each ultrasound cyclone chamber UCR 40 comprises a lower tangential inlet 42 connected to receive the second stream S2 a cyclone chamber configured to cyclonically deliver the inlet second stream S2; an ultrasound generator (not shown) comprising an array of transducers arranged to sonicate oil, salts and heavy metals contained in the second stream S2 as it is delivered through the cyclone chamber and to accelerate dropping of solids to a bottom outlet 49 in the cyclone chamber; a top outlet 44, associated with a pressure relief valve 70 and a flashback flame arrestor 72, to release generated gases; and a further outlet 48 associated with a solenoid valve 74 to deliver clean oil.

FIG. 6 is a schematic view of the ultrasound cyclone chamber UCR 40 showing in detail a cut away view of its lower tangential inlet 42 through which the second stream S2 is introduced and sonicated, producing an inverse cyclonic circulation in the cylindrical chamber.

As shown in FIG. 2, the six electro-kinetic reactors EKR 20 and water tank clarifiers WT 30 and the two ultrasound cyclone chambers UCR 40 are interconnected as follows. The involute inlets 22 of all electro-kinetic reactors EKR 20 are all connected to a common supply conduit 50 of the first stream to receive the first stream S1. The top outlets 26 of all electro-kinetic reactors EKR 20 and the top outlets 44 of the cyclone chambers UCR 40 are all connected to a common gas extraction conduit 60 for released HHO gas. The clean water outlets 36 of all water tank clarifiers WT 30 are all connected to a common clean water delivery conduit 62. The outlets 28 of the bottom funnels of all electro-kinetic reactors EKR 20, the outlets 36 in the bottom of all water tank clarifiers WT 30, and the bottom outlet 28 in each ultrasound cyclone chamber UCR 20 are all connected to a common solids separation conduit 64.

The inventive installation can be controlled by a Programmable Logic Controller PLC designed and programed not only to automatically control its operation but also to improve the exposure time and to provide operational and maintenance alarms to the operators.

All solenoid valves 74 are automatically controlled by a special design and programed PLC that other than operations control has the objective of maximizing exposure time and to provide operational and maintenance alarm.

All electrical actuators, valves, equipment, connections, panels and programmable logic computers PLC are designed accordingly with ATEX regulations for hazardous materials.

In operation, a first stream S1 of a colloidal suspension of water and ultra-fine electrically charged particles is delivered and controlled via a flow indicator and a transducer to the inlets of the electro-kinetic reactors EKR 20 via the common supply conduit 50 and a second stream S2 of heavy oil is delivered to the tangential inlet 42 of each ultrasound cyclone chamber 40, both of these streams having been derived from treating a flow of heavy crude oil or bitumen for example as described with reference to FIG. 1.

Overall, in operation, the following valuable outputs are produced:
Gases are removed via the common gas extraction conduit 60 that is connected to the top outlets 26 of all electro-kinetic reactors EKR 20 and the top outlet of 44 each ultrasound cyclone chamber UCR 40. The removed gases constitute a valuable by product that can be delivered to for further use by customers to replace or minimize the use of natural gas and to produce electricity and thereby offset the cost of electricity, and reduce the carbon footprint.
Clean water is removed via the common clean water delivery/separation conduit 62 connected to the clean water outlets of the water tank clarifiers WT. The clean water can be recirculated to the installation of FIG. 1.
Separated solids are removed via the common solids separation conduit 64 that is connected to the outlets 28 of the bottom funnels of the electro-kinetic reactors EKR 20, the outlets 36 in the bottom of the water tank clarifiers WT 30, and the bottom outlet 49 in the ultrasound cyclone chambers UCR 40. The separated solids constitute a useful by-product that can either be sold to an asphalt production company or gasified to produce electricity using the generated gases.
Clean and more valuable commercial quality oil is removed from the further outlet 48 in each ultrasound cyclone chamber UCR 40.

Furthermore in operation: the first stream S1 is electrolyzed between facing anodes and cathodes 24 in each electro-kinetic reactor EKR 20. Generated HHO gases are released via the top outlet 26 of each electro-kinetic reactor EKR 20 through the pressure release valve 70 and flame arrester 72. Partly clarified water containing ultra-fine ferric material is removed via the lower outlet 27 of each electro-kinetic reactor EKR 20 through its solenoid valve 74, and decanted solids are extracted via the outlet 28 in the bottom funnel of each electro-kinetic reactor EKR 20 with its solenoid valve 74.

The first stream S1 is typically electrolyzed in each electro-kinetic reactor EKR 20 with an effect of electro flocculation due to the release of metal anions such as Fe+, from the anodes, and produced flocculated material is removed from the electro-kinetic reactor EKR 20 via its lower outlet 28.

The first stream S1 can for example be circulated in each electro-kinetic reactor 20 around circular circulation paths defined between the facing anodes and cathodes 24. Circulation of the first stream S1 around the circular paths in the EKR 20 is promoted by the reactor's involute inlet 22.

The first stream S1 of contaminated water and ultra-fine solids in colloidal dispersion enters the EKR 20's involute inlet using a distribution manifold that increases residence time inside each electrokinetic reactor EKR and minimizes the use of DC electrical current.

The EKRs 20 involve a combination of hydro cyclone, electro flocculation and magnetic forces arranged to maximize the exposure of the water to the electrodes arranged in such a way that they utilize the fact that these waters have a large negative surface charge.

The arrangement also breaks down the electrical double layer on the particles that keeps ultrafine particles in suspension. The arrangement also flocculates light solids utilizing the heat produced by the electrodes (clay expansion) and the bubbles of HHO generation. As a result, solids of greater weight and diameter are decanted. The energy efficiency of the system is also maximized.

Partly clarified water is delivered from the lower outlet 28 of each electro-kinetic reactor EKR 20 to the upper inlet 32 of its water tank clarifier WT 30.

Ultra-fine ferric material in the partly clarified water contained in each water tank clarifier WT 30 is magnetically urged towards the outlet 36 in its bottom, and clean water is removed from the outlet 36 each water tank clarifier WT 30 with its solenoid valve.

The second stream S2 40 cyclonically passes through the ultrasound cyclone chamber UCR by introducing it through its tangential inlet 42 and via a manifold controlled with flow indicator and flow transducer.

The UCR 40 combine a special cyclone Involute inlet 42 and transducers are placed in an array to maximize the sonication of the oil, salts and heavy metals. The treated oil follows the path of the cyclone that maximize the exposure of the material to the sonication effect, as follows.

Ultrasound is generated in the array of transducers in the ultrasound cyclone chamber UCR 40 to sonicate oil, salts and heavy metals contained in the second stream as it is delivered through the cyclone chamber to accelerate dropping of solids to the bottom outlet 49 in the cyclone chamber UCR 40 the ultrasound energy is applied as ultrahigh-frequency ultrasound, 32 KHz, high-frequency ultrasound, 28 KHz, or low-frequency ultrasound, 18 KHz, depending on the nature of the main characteristics of the media that contains the colloids.

The exposure of the oil to the sonication is maximized in such a way that the impedance will be minimized, and the intensity of the acoustic field is optimized to break the emulsion, reduce sulfur content, make the asphaltene out of equilibrium and then drop along with same salts like calcium carbonate, heavy metals and solids. It also accelerates the solids dropping to the bottom of the tank and maximizes the energy efficiency of the system.

In the UCR 40 gases are generated. The gases are a combination of hydrogen produced by the ultrasound plus oil gases produced during the hydrocarbon's molecule fracture plus volatile organic compounds VOC. The Ultrasound creates pressure zones that create bubbles of high pressure and temperature that when they explode, increase the temperature and fracture some but not all oil and water molecules. Hydrogen is created from water and other gases from the oil.

The overall effect is to upgrade the oil and create gases in small and easy to control volumes.

The created gases outlet via the top outlet 26 of each cyclone chamber UCR 20, via the pressure relief valve 70 and flashback flame arrester 72. Finally clean oil is delivered via the further outlet 48 in the ultrasound cyclone chamber UCR 40 via its solenoid valve 74.

### MODIFICATIONS

The installation illustrated in FIG. 2 with six electro-kinetic reactors EKR 20 and two ultrasound cyclone chambers UCR 40 was designed to treat the streamlines of an original volume of 300 BB/h (barrels per hour) but can be adjusted to treat smaller or larger volumes. As a minimum, the installation should comprise two to four electro-kinetic reactors EKR 20 and one ultrasound cyclone chamber UCR 40. A smaller installation could for example comprise four electro-kinetic reactors EKR 20 and two ultrasound cyclone chambers UCR 40

The inventive installation can also operate with an input second stream S2 of partly clarified oil and partly clarified water. In this case the ultrasound cyclone chamber(s) UCR 40 for separating oil and solids can be complemented with a cyclone for separating water that can be delivered to the common clean water outlet conduit 62 of the water tank clarifiers WT 30.

1-12. (canceled)

13. An installation for treating first and second streams and both of which streams and are derived from treating a flow of heavy crude oil or bitumen, wherein the first stream is a colloidal suspension of water and ultra-fine particles derived from treating the flow of heavy crude oil or bitumen, and the second stream is a stream of heavy oil derived from treating the flow of heavy crude oil or bitumen, and wherein the installation is arranged to convert the first and second streams into separate streams of clean water and clean oil, as well as decanted solids and released gases,
the installation comprising:
a plurality of electro-kinetic reactors and water tank clarifiers connected in parallel to receive and treat the first stream; and
at least one ultrasound cyclone chamber connected to receive and treat said second stream,
wherein
each electro-kinetic reactor comprises:
an involute inlet connected to receive said first stream;
a set of spaced apart anodes and cathodes arranged in the reactor to electrolyze said first stream;
a top outlet arranged to release generated gases;
a lower outlet arranged to extract partly clarified water containing ultra-fine ferric material; and
a bottom funnel with a bottom outlet arranged to extract decanted solids;
each water tank clarifier comprises:
an inlet connected to the lower outlet of the electro-kinetic reactor to receive the partly clarified water;
an electro-magnetic belt surrounding the water tank clarifier and arranged to magnetically urge the ultra-fine ferric material in the partly clarified water towards the bottom of the water tank clarifier;
an outlet in the bottom of the water tank clarifier arranged to remove solids; and
a clean water outlet; and
the or each ultrasound cyclone chamber comprises:
a tangential inlet connected to receive said second stream;
a cyclone chamber configured to cyclonically deliver the inlet second stream;
an ultrasound generator comprising an array of transducers arranged to sonicate oil, salts and heavy metals contained in said second stream as it is delivered through the cyclone chamber and to accelerate dropping of solids to a bottom outlet in the cyclone chamber;
a top outlet arranged to release generated gases; and
a further outlet in the cyclone chamber arranged to deliver clean oil;
wherein the plurality of electro-kinetic reactors and water tank clarifiers and the or each ultrasound cyclone chamber are interconnected as follows:
the involute inlets of all electro-kinetic reactors are all connected to a common supply conduit (50) of said first stream to receive said first stream;
the top outlets of all electro-kinetic reactors and the top outlet of the or each cyclone chamber are all connected to a common gas extraction conduit;
the clean water outlets of all water tank clarifiers are all connected to a common clean water delivery conduit; and
the outlets of the bottom funnels of all electro-kinetic reactors, the outlets in the bottom of all water tank clarifiers, and the bottom outlet in the or each ultrasound cyclone chamber are all connected to a common solids separation conduit.

14. The installation of claim 13, wherein the top outlet of each electro-kinetic reactor and the top outlet of the or each ultrasound cyclone chamber is connected to the common gas extraction conduit by a pressure relief valve and a flame arrester.

15. The installation of claim 13, wherein each inlet and each outlet of the electro-kinetic reactors, of the water tank clarifiers is controlled with a solenoid valve.

16. The installation of claim 13, wherein each water tank clarifier is a cyclone with an upper tangential inlet and a lower clean water outlet, wherein the upper tangential inlet is connected to the lower outlet of the electro-kinetic reactor to receive the partly clarified water.

17. The installation of claim 13, wherein the spaced apart anodes and cathodes of each electro-kinetic reactor comprise an array of interleaved part-cylindrical anodes and cathodes disposed concentrically and spaced-apart with equal spacings.

18. The installation of claim 17, wherein each electro-kinetic reactor comprises two sets of equal facing half cylindrical anodes and cathodes each disposed concentrically and spaced-apart with equal spacings, the two sets of equal facing half cylindrical anodes and cathodes making up a generally cylindrical array with facing halves separated by a radially-extending gap across which extremities of the anodes and cathodes of the two sets face one another, and wherein the facing anodes and cathodes of the generally cylindrical array define circular circulation paths for the first stream.

19. A method of treating a first stream of a colloidal suspension of water and ultra-fine particles and a second stream of heavy oil, both of which streams are derived from a treating flow of heavy crude oil or bitumen, to convert the first and second streams into separate streams of clean water and clean oil, decanted solids and released gases, the method comprising providing the installation of claim 13 and:
delivering said first stream to the inlets of the electro-kinetic reactors via the common supply conduit, delivering said second stream to the tangential inlet of the or each ultrasound cyclone chamber,
removing gases via the common gas extraction conduit that is connected to the top outlets of all electro-kinetic reactors and the top outlet of the or each ultrasound cyclone chamber,
removing clean water via the common clean water delivery conduit connected to the clean water outlets of the water tank clarifiers,
removing separated oils via the common solids separation conduit that is connected to the outlets of the bottom funnels of the electro-kinetic reactors, the outlets in the bottom of the water tank clarifiers, and the bottom outlet in the or each ultrasound cyclone chamber, and
removing clean oil from the further outlet in the or each ultrasound cyclone chamber.

20. The method of claim 19, comprising:
electrolyzing said first stream between facing anodes and cathodes in each electro-kinetic reactor;
releasing generated gases via the top outlet of each electro-kinetic reactor;
extracting partly any clarified water containing ultra-fine ferric material via the lower outlet of each electro-kinetic reactor; and
extracting decanted solids via the outlet of each electro-kinetic reactor's bottom funnel.

21. The method of claim 20, wherein said first stream in electrolyzed in each electro-kinetic reactor with an effect of electro flocculation, and produced flocculated material is removed from the electro-kinetic reactor via a further outlet.

22. The method of claim 19, said method comprising circulating said first stream in each electro-kinetic reactor around the circular circulation paths between the facing anodes and cathodes, wherein each electro-kinetic reactor comprises two sets of equal facing half cylindrical anodes and cathodes each disposed concentrically and spaced-apart with equal spacings, the two sets of equal facing half cylindrical anodes and cathodes making up a generally cylindrical array with facing halves separated by a radially-extending gap across which extremities of the anodes and cathodes of the two sets face one another, and wherein the facing anodes and cathodes of the generally cylindrical array define circular circulation paths for the first stream.

23. The method of claim 19, comprising:
delivering partly clarified water from the lower outlet of each electro-kinetic reactor to the upper inlet of its water tank clarifier;
magnetically urging ultra-fine ferric material in the partly clarified water contained in each water tank clarifier towards the in its bottom; and
out letting clean water from each water tank clarifier.

24. The method of claim 19, comprising:
cyclonically delivering said second stream through the ultrasound cyclone chamber, generating ultrasound in the array of transducers in the ultrasound cyclone chamber to sonicate oil, salts and heavy metals contained in said second stream as it is delivered through the cyclone chamber to accelerate dropping of solids to the bottom outlet in the cyclone chamber, and generate gas,
out letting generated gases via the top outlet of the or each cyclone chamber, and
delivering clean oil from said further outlet in the ultrasound cyclone chamber.
